(19) United States
(12) Patent Application Publication
(10) Pub. No.: US 2004/0188351 A1
(43) Pub. Date: Sep. 30, 2004

(54) Method for reducing an adsorption tendency of molecules or biological cells on a material surface

(76) Inventors: Thomas Thiele, Berlin (DE); Rudiger Storm, Berlin (DE); Heike Matuschewski, Berlin (DE); Uwe Schedler, Berlin (DE)

Correspondence Address: KRIEGSMAN & KRIEGSMAN, 665 FRANKLIN STREET, FRAMINGHAM, MA, 01702, US

(21) Appl. No.: 10/477,390

(22) PCT Filed: May 8, 2002
(86) PCT No.: PCT/EP02/05095

(30) Foreign Application Priority Data
May 11, 2001 (DE) 101 23 296.9

(51) Int. Cl. C02F 1/44

(52) U.S. Cl. 210/645

(57) ABSTRACT

The invention concerns a method for reducing a tendency toward adsorption of molecules or biological cells from solutions or suspensions on a material surface placed in contact with the solution or suspension, as well as a use of the method, and a method for the production of a material with reduced tendency toward adsorption of molecules or biological cells from solutions or suspensions, which is suitable for conducting this method. It is provided that an organic or inorganic support material with a modified surface is used as the material, and that the surface is modified by in-situ polymerization of monomers which are selected as a function of a property of the molecule or the cell, onto the surface.

The invention concerns a method for reducing a tendency toward adsorption of molecules or biological cells from solutions or suspensions on a material surface placed in contact with the solution or suspension according to claim 1, a method for the production of a material suitable for the method according to claim 13, as well as uses of the method according to claims 15 to 19.

The contamination of solid surfaces in contact with aqueous media due to biofilm formation is a problem known as “fouling”. For example, in ships, there occurs an algae growth on ship hulls and in the case of medical implants, uncontrolled depositions build up on implant surfaces that come into contact with body fluids (also denoted biofouling or biocorrosion). In the case of technical filtration processes through membranes, a fouling of the membrane is also observed, which is frequently caused by depositions of proteins (so-called membrane fouling), which can lead to blockages of the membrane pores. In the case of protein fouling of membranes, the causes of biofilm formation can be reduced to two essential processes. First of all, a protein aggregation occurs at the membrane surface/solution interface or in the solution, followed by a deposition of the aggregate on the membrane surface. Secondly, a nonspecific protein adsorption of unaggregated proteins occurs on the surface. As a consequence of this, after a fairly long time, there can arise colonies of microorganisms or complex structures (as in the case of ship hulls).

Different factors influencing the extent of protein fouling are discussed, including the structure of the protein in solution, chemical and physical properties of the surface or process conditions, and strategies for reducing protein fouling have been developed. Nevertheless, there is still an insufficient understanding of the nature of the interactions that lead to protein fouling. Therefore, at the present time, approaches to avoiding fouling are often empirical and include often a chemical modification of the surface that makes it hydrophilic or hydrophobic.

The object of the invention is to make available a new method for reducing the tendency toward adsorption of different materials when confronted with molecules and/or biological cells. Thus, objects with a material surface that counteracts fouling will be provided, whereby the method will have a broad range of variation with respect to the chemical, physical or structural properties of specific molecules or cells, in order to consider as many fields of application as possible. The method will be particularly suitable for application in the food industry, medicine, biotechnology, wastewater treatment and/or shipbuilding.

This object will be solved by a method with the features named in claim 1, a method for the production of a material suitable for conducting the method according to claim 13, as well as by its uses according to claims 15 to 19.

According to the invention, the method provides that an organic or an inorganic support material with a modified surface is used as the material, whereby the surface modification occurs by in-situ polymerization of monomers, which are selected as a function of a property, particularly a chemical, physical and/or steric property of the [specific] molecule or the cell, onto the surface. Since the in-situ polymerization conducted directly at the material surface permits a surface modification with covalent binding of monomers of the most varied properties, according to the invention, an antifouling material with a surface with reduced tendency toward adsorption is offered, which is tailored individually for the specific fouling problem. The chemically covalent antifouling modification also has the advantage of long-lasting stability. Thus, the method is suitable also for application in long-term applications, such as for the modification of ship hulls according to the invention. A very retarded biofilm formation results in this case, and also of algae growth as a consequence of this. A generally increased lifetime results for membrane applications, along with a membrane performance that remains the same.

The monomers used determine the antifouling properties of the material. The monomer is preferably selected as a function of an electrostatic charge and/or a polarity and//or spatial structure of the molecule or of the cell that is to be repelled, particularly its outer surface and, in fact, such that the modified material surface has an affinity to the molecule or to the cell that is as small as possible.

In particular, for example, a monomer with an electrostatic charge of the same sign and/or a polarity of comparable intensity to the molecule or the cell is selected. For example, material surfaces that are made hydrophilic are offered for the inhibition of protein adsorption, that is, surfaces modified with a polar monomer, which to a great extent inhibits the first step, the non-specific accumulation of water-soluble proteins that are equipped with a hydrophilic outer molecular surface. Preferably, anionic or cationic or even multifunctional surfaces are produced and monomers suitable for this [modification] are selected in order to obtain the hydrophilic property against protein fouling. Also, surfactant monomers are used.

As a result, the tendency toward adsorption of material surfaces can be reduced in a targeted manner when confronted with a plurality of specific molecules (or substance groups) and/or cells, in order to inhibit the fouling process. In particular, the selection of the monomer can be made in such a way that the material is given a reduced tendency toward adsorption for proteins, peptides, peptoids, peptidomimetics, enzymes, antibodies, inoculation substances, nucleic acids, particularly DNA, RNA or plasmids carbohydrates, glucans, humic substances and/or derivatives of the above-named substances and/or for other organic molecules and/or small particles. Likewise, a reduced tendency toward adsorption can be achieved for microbial cells, particularly for bacteria, fungi, viruses, blood cells, tissue cells and/or the like, by suitable monomer selection.

The monomer selected according to the criteria indicated above must be provided with a group that is capable of polymerization and can also react with the support material, for example, it has a double bond, which permits a covalent binding to the material surface, which is optionally pretreated. The modification can be produced by chemical or photochemical grafting, by radical or ionic polymerization or polymer crosslinking. Of these methods, photo-induced graft polymerization is preferred within the scope of the present invention. The monomer can be selected particularly from the following group: methyl methacrylate, methyl acrylate, hydroxyethyl methacrylate, polyethylene glycol monomethacrylate of different chain lengths (M=200, 400, 526, 1000, . . . ), N-isopropylacrylamide, diethylacrylamide, methacrylic acid, acrylic acid, acrylamide propanesulfonic acid, carboxylic acid derivatives with polymerization-capable groups, sulfonic acid derivatives with polymerization-capable groups, phosphoric acid derivatives with polymerization-capable groups, styrene sulfonic acid, styrene phosphoric acid, polymerization-capable ammonium, sulfonium and phosphonium derivatives, bi- and polyfunctional monomers, polymerisation-capable derivatives based on polyimides, heparin, fluorinated polymerization-capable monomers, monomers based on amino acids, carbohydrates, acrylamide, polymerization-capable detergents, alkyls of different chain lengths with polymerization-capable groups, hexyl methacrylate, tert-butyl methacrylate. Of course, other monomers which are optimized relative to the polymer support material as well as to the substance whose adsorption is to be inhibited can also be used. The use of monomer mixtures comprised of two or more selected monomers is also conceivable within the scope of the present invention.

The support material can comprise the most varied materials, preferably those which withstand the usual cleaning or purification procedures used in the industry. Organic polymer materials represent particularly well-suitable polymer materials, particularly polysulfone, polyether sulfone, polyolefin, as well as polypropylene or polyethylene, polyamide, polyester, polycarbonate, polyacrylonitrile, polyvinylidene fluoride, polytetrafluoroethylene, polyacrylate, polyacrylamide, cellulose, amylose, agarose, or derivatives thereof, with different morphologies. Usually, the in-situ polymerization of a suitable monomer can be conducted on these materials without additional pretreatment of the material surface.

However, inorganic polymers, particularly metal, glass, silicate, ceramic, or the like are also suitable as the support material. Since such materials are frequently inaccessible to modification with the monomer without further treatment, the surfaces can be optionally chemically pretreated or can be coated with an organic polymer material prior to the modification, in order to establish a functional group on the material surface, which is capable of reaction with the monomer. For example, glasses or ceramics can be pretreated in the known way by silanizing with a suitable silane.

The material can also be reinforced externally or internally by an additional inert support or particles, fibers or networks of polymer, glass or metal, such as is known, for example, from support-reinforced ceramic membranes. Depending on the objective each time, base materials for the production of antifouling-modified materials can be selected from this spectrum or from other materials. For antifouling membranes for example, for the filtration of beer, preferably flat membranes of polyether sulfone (PES) or polysulfone (PSU) are selected as the material.

The method according to the present invention can be used advantageously for the production or modification of the most varied objects of porous or non-porous structure that come into contact with the solution or the suspension. The method can be used particularly advantageously for inhibiting fouling in the case of porous membranes which are utilized for the filtration or dialysis of the solution or suspension and which can be appropriately modified according to the invention. Ultra- or microfiltration membranes are particularly advantageously used here, particularly when they are made of an organic polymer material, with a symmetric or asymmetric pore structure and a pore size in a range of nm to μm. In addition, porous materials, particularly sintered materials, such as ceramic membranes, or non-porous materials can also be modified and used according to the invention, particularly films, foils, flexible tubings, pipelines, dialysis materials, receptacles, catheters, infusion needles, drainage systems, medical implants, reactors, or the like.

The large range of monomers that can be applied onto material surfaces permits the use of the antifouling method according to the invention in a plurality of fields of application.

The method, particularly with the use of surface-modified membranes according to the invention, can be utilized particularly advantageously in filtration processes in food technology, particularly for sterile or clear filtration of liquid nutrients or drinks, particularly of beer, wine, fruit juices or dairy products.

The advantage of the present invention will be explained in more detail on the example of beer filtration. In order to produce a perfect taste and a fine luster, beer is usually subjected to a filtration (clarification). Turbidity formers, such as albumin-tannin compounds, hop resins, yeast cells and also bacteria that are damaging to beer and may still be present, are removed in several filtration steps. In addition to the optic and sensory properties, the preservability of the beer is also improved. Pressure and temperature differences must be avoided during the entire filtration process, so that the carbon dioxide dissolved in the beer does not produce foam. The beer filtration will be divided into three segments: pre-clarification, beer stabilization and clarification or sterile filtration. Usually, ultrafiltration membranes of polyether sulfone (PES) with a pore width of 0.45 μm are utilized, particularly in the last-named filtration segment. Conventionally, this filtration step is very much affected by fouling processes, wherein the fouling occurs in the form of a non-specific blocking of the filtering means, such as, for example, diatomaceous earth, polyvinylpolypyrrolidone (PVPP) and β-glucans, on the membrane surface. The main factor that is responsible for the occurrence of filtration problems and the formation of turbidity during storage is the tendency for β-glucans to form gels, which is reinforced particularly by high shearing forces. The consequences include short service lives of the membranes utilized, low flow-through rates and reduced filter performances. According to the prior art, blockages thus occur in a relatively short time with a large tangential flow of beer onto the filter medium. Useful results with acceptable filter service lives are obtained at the present time only with a slow flow of approximately 1 to 3 hl/qm h.

In contrast to this, a surface-modified ultrafiltration membrane according to the invention can reduce the fouling process in beer filtration at higher tangential flow rates onto the membrane surface. This leads to the circumstance that the purification cycle can be reduced and the lifetime of the membrane is increased. The gel formation of β-glucans, in fact, cannot be completely prevented, but it can be minimized by the reduced affinity and adsorption behavior of the functionalized membrane by deposits on the membrane surface that give rise to gel layers. One advantage of the use of a modified membrane according to the invention lies in the fact that an increase in lifetime (service life) of the membrane of at least 30% can be achieved. In addition, the method permits approximately 50% higher filter outputs in comparison to currently available systems. Finally, due to an essential reduction of the purification cycle approximately 20% less process water is required for the backwashing and can thus be spared. In addition, the costs for personnel, maintenance, energy and disposal can be minimized.

Another preferred application of the antifouling method according to the invention is in medical technology, wherein the surface-modified material is used for objects which are found in long-term contact with patients, particularly with tissues or body fluids of any type. Application to infusion needles, cannulas, catheters, implants, and the like are particularly considered.

In addition, appropriately modified antifouling materials can find use in biotechnology or in the drug industry, wherein the material can be used particularly for articles for the filtration of fluids, for the concentration of substances from fluids, for de-salting, for dead-end filtration, in cross-flow applications or the like.

Finally, the antifouling materials according to the invention can be utilized for articles that come into contact with bodies of water. In particular, (plastic-coated) metal hulls of ships can be provided with an antifouling modification, which counteracts a colonization of microorganisms and complex structures.

Likewise, the method can be utilized in wastewater purification, particularly for the purification of municipal sewage, wastewater from technical processes in industry or wastewater of medical equipment, wherein the material with surface modified according to the invention is also used here for objects in long-term contact with a body of water, particularly for filters or tanks.

The material with reduced tendency toward adsorption for molecules or biological cells from solutions or suspensions, which is suitable for conducting the method according to the invention, is produced by surface modification of the support material by in-situ polymerization of selected monomers on the surface, preferably by photo-initiated heterogeneous graft polymerization with the production of graft polymers of suitable monomers covalently bound to the material surface. The method is particularly advantageously conducted with intense surface selectivity relative to the support material, i.e., with the formation of radicals, which remains greatly limited to the material surface and excludes an adverse effect on the material. The method is also characterized by a very uniform layer thickness distributed over the entire surface. The antifouling materials can therefore be obtained according to a method which essentially is comprised of the following steps:

i) The support material is first surface-coated with a suitable photoinitiator, which can produce radicals on the support surface after excitation by light, preferably by abstraction of hydrogen and thus without degradation of the polymer matrix of the support material.

ii) The coated support material is then exposed to light of suitable wavelength (for example, of the UV region) in the presence of a selected functional monomer or monomer mixture, whereby a functional layer, which is comprised of functional graft polymers not cross-linked to one another and covalently anchored to the support material, is formed. The exposure is preferably produced selectively, so that only the photoinitiator is excited.

iii) Finally, unreacted monomers, photoinitiator, as well as soluble homo- or copolymers or photoinitiator secondary products are extracted from the support material.

Also, a sequential activation/initiation of the graft polymerization is possible, in that, first, the exposure of the support material coated with the photoinitiator according to step i) in the presence of oxygen or with subsequent exposure to oxygen takes place with the formation of peroxides of the support material and then the reaction with the monomer is thermally initiated. Other heterogeneous chemically-initiated reactions for initiating a graft polymerization are also applicable.

Benzophenone and structurally-related ketone derivatives are particularly suitable as the photoinitiator. The coating with the photoinitiator in step i) from a solution that is not a solvent for the polymer matrix can be conducted by dip coating or impregnation; however, it may optionally be carried out without additional process steps directly from the graft copolymerization described in step ii), by adsorbing the photoinitiator from a mixture of initiator, monomer or monomer mixture and optionally a solvent, onto the support surface.

With the support material given above that has an appropriate homogeneous or porous structure and thus a specific surface of variable size, the degree of functionalization and thus the charge per unit of surface can be adjusted within a broad range by means of the graft polymerization conditions (photoinitiator coating, monomer concentration, exposure time). With the selection of suitable conditions (light absorption of photoinitiator and support material), uniform functionalizations of thick porous layers are possible.

The preferably applied photomodification permits the reproducible and uniform functionalization of large continuous organic or inorganic polymer materials by a rapid and effective method.

Additional advantageous configurations of the invention are the subject of the remaining dependent claims.

The invention will be explained in more detail below in the examples of embodiment based on the figures, which show:

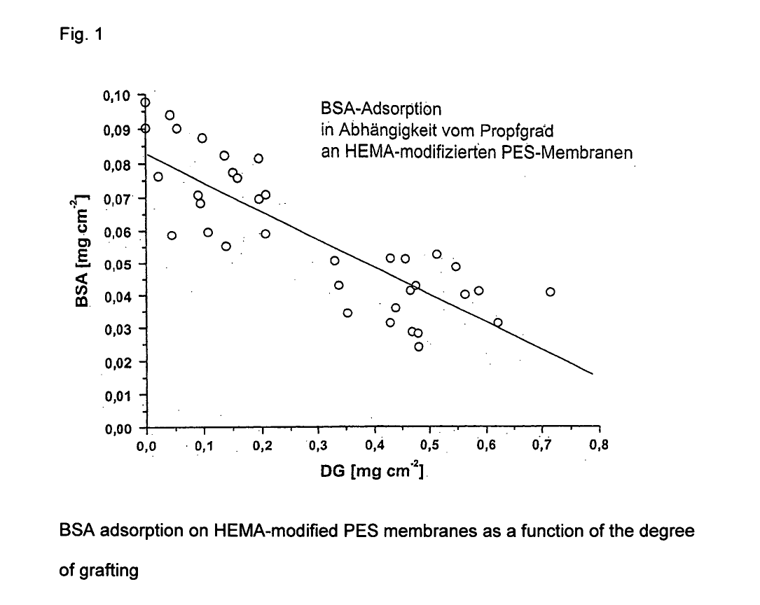

FIG. 1 Adsorption of BSA on HEMA-modified PES membranes as a function of the degree of grafting;

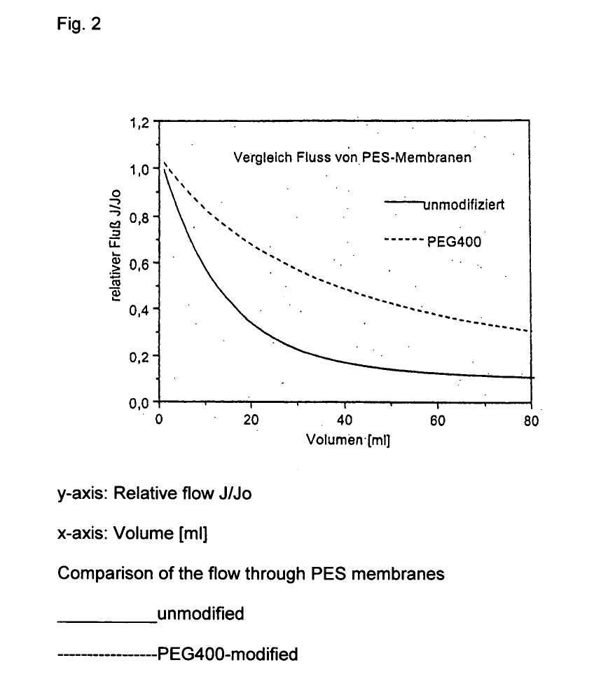

FIG. 2 Relative flow through PEG400-modified and unmodified PES membranes as a function of volumes that have passed through;

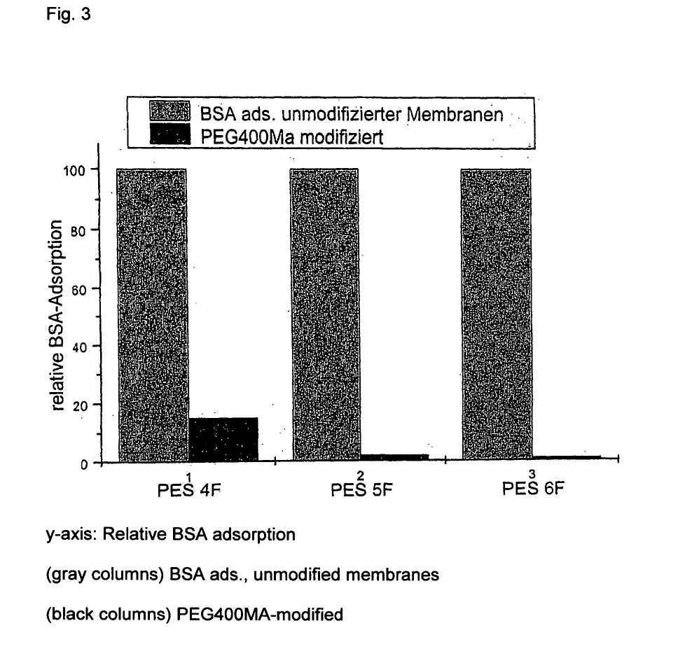

FIG. 3 Comparison of the filter passage of BSA on PEG400MA-modified and unmodified PES membranes of different pore size and

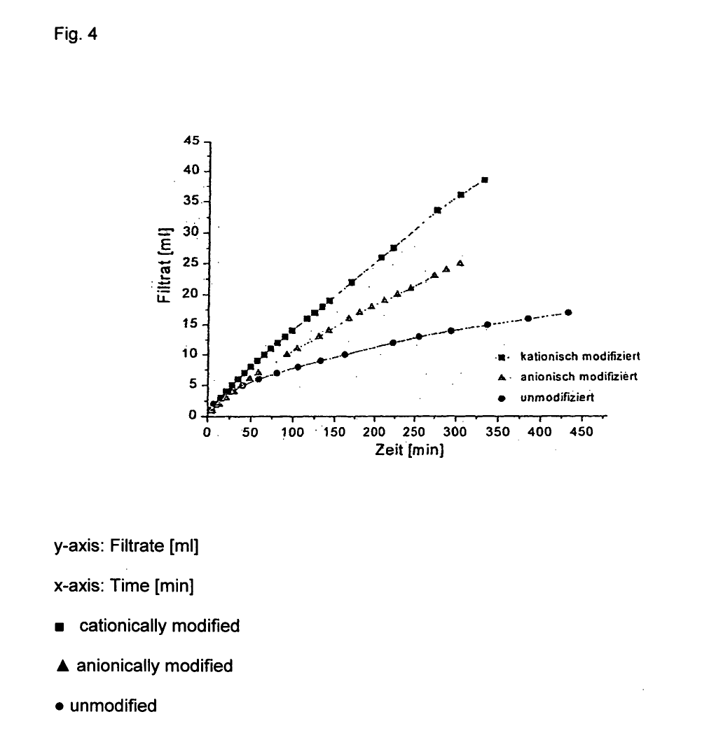

FIG. 4 Comparison of the filter output of anionically and cationically modified and unmodified ceramic membranes as a function of the duration of filtration.

### EXAMPLE 1

### Modification of PES/PSU Membranes with Photografting

Preparation and Preliminary Extraction of PES/PSU Materials

Tailored-to-fit membranes (for example, DIN A4) of polyether sulfone (PES) or polysulfone (PSU) are carefully extracted for approximately 1 hour in methanol at 40° C. After the membranes are dried, they are weighed.

Loading with Photoinitiator

A defined concentration of a photoinitiator solution (for example, 0.15 M benzophenone (BP) in methanol) is first examined photometrically, for example, and optionally corrected. The solution is filtered prior to loading. The membrane is placed for 10 minutes in a suitable vessel containing the initiator solution. After removal, the membrane is dried and the adsorbed quantity of photoinitiator is gravimetrically determined by differential weighing. Then the membrane is placed in a prepared, degassed solution of the monomer. The standing time amounts to 30 minutes, during which a slight flow of nitrogen is introduced.

Photografting

The reaction vessel with the membrane covered with the monomer solution is subjected to the necessary dose of radiation with a filter suitable for the photoinitiator each time, according to specification (depending on the desired degree of grafting). After irradiation has been terminated, there is a post-reaction time of 15 minutes followed by transfer to post-extraction.

Post-Extraction

The membranes that are photochemically modified according to the above-named method are first extracted with deionized water at 50° C. Then the membranes are extracted in sufficient methanol at 40° C. The extraction is repeated for a sufficient amount of time until residues of the photoinitiator are no longer contained in the membrane.

The membranes obtained according to this general method are particularly suitable for beer filtration, as is clear from the following examples based on affinity investigations of PES membranes of different pore size that have been surface-modified in different ways when subject to the deposition of bovine serum albumin (BSA).

### EXAMPLE 2

### Tendency Toward Adsorption of BSA on HEMA-Modified PES Membranes

PES membranes are modified according to the general instructions according to Example 1 with the monomer hydroxyethyl methacrylate (HEMA). In this way, different grafting degrees in the range of 0 to 0.8 mg/cm² are obtained by variation of the radiation dose during the photografting. Then the HEMA-modified membranes are brought into contact with a 1% aqueous solution of bovine serum albumin (BSA) for two hours for the determination of nonspeciffic adsorption. The degree of loading of the membranes with BSA is determined subsequently by differential weighing of the dried membranes before and after the BSA incubation. As can be seen from FIG. 1, the BSA loading of the membranes decreases approximately linearly with increasing degree of HEMA grafting. A reduction of BSA loading by approximately 60 to 70% is obtained in comparison to unmodified membranes for a degree of grafting of 0.7 mg/cm².

### EXAMPLE 3

### Tendency Toward Adsorption of BSA to PEG400-Modified PES Membranes

PES membranes (3×3 cm) of different pore size [0.45 μm (PES 4F), 0.50 μm (PES 5F), 0.55 μm (PES 6F)] are modified according to the general instructions according to Example 1 with the monomer polyethylene glycol 400 (PEG400), and a degree of grafting in the range of 35 to 46 mg/g is obtained.

The flow-through rate of PEG400-modified membranes is then determined after passage of different volumes of a solution of 1% BSA in buffer in comparison to an unmodified PES membrane. The membranes are mounted each time in a pressure filtration cell (Amicon 8010) and the passage time required for 1 ml of solution at 1.5 bars excess pressure is determined by means of a measuring device. As is clear from FIG. 2, the flow rate of the modified membrane decreases significantly more slowly when compared to the unmodified membrane with cumulative passage of the protein solution. PEG400-modified membranes of different pore size are brought into contact with an aqueous solution of bovine serum albumin (BSA) for a defined period of time, analogously to Example 2, and then the adsorption of BSA on the membranes is determined in comparison to that of unmodified PES membranes. The results are shown in FIG. 3, where the BSA loading of the modified membranes is shown each time in relation to the unmodified membranes (100%). It is clear that the PEG400 modification reduces the protein fouling by at least 80%.

### EXAMPLE 4

### Modification of Ceramic Membranes with Photografting Making the Membrane Hydrophobic

Ceramic membranes with special steel backing sheet and a pore size of 30 nm are silanized for 24 hours at the boiling point under reflux cooling in a solution of 5% trimethoxypropylsilane in toluene, without further pretreatment. Then the ceramic membranes are extracted with toluene and subsequently dried.

Coating with Photoinitiator

The ceramic membranes are immersed in a solution of 80 mmolar benzophenone in methanol for one hour.

Grafting

Ceramic membranes are transferred from the BP solution into a monomer solution of defined concentration and then left to stand for 15 min. In this way, styrene sulfonic acid-Na (anionic) or Pleximon 760 (2-trimethylammonium ethyl methacrylate chloride; cationic) will be used as the monomer. Then UV irradiation of a defined dose is conducted.

### Extraction

After photografting has been conducted, an extraction is carried out first in H₂O for one hour and then in methanol for one hour.

The thus-modified ceramic membranes are particularly suitable for the treatment of municipal sewage or wastewaters of industrial processes. Due to the small pores, this material is suitable also for treatment of drinking water or for treatment of wastewater of medical devices, since it can also remove viruses and bacteria from the water.

### EXAMPLE 5

### Tendency Toward Adsorption of BSA Onto Anionically or Cationically Modified Ceramic Membranes

The anionically or cationically modified ceramic membranes prepared according to Example 4 are subjected to flow measurements with a BSA solution in acetate buffer (pH 4.75). For this purpose, the membranes were first moistened with methanol and then a 1% BSA solution in acetate buffer (pH 4.75) was filtered though the membranes.

The flow curves of an unmodified membrane are shown in FIG. 4 in comparison to the two modified variants. An increasing blockage of the membrane is clear in this type of deposition as shown by the increasing flattening of the curves. Correspondingly, a completely stopped-up membrane is characterized by a horizontal line. It can be clearly seen that the membranes initially have very similar flow performance, but clear differences occur with increasing filtration time. The samples modified according to the invention each time show improved flow performance in comparison to the unmodified membrane. The differences between the modified samples can be clarified by the measurement system used.

### Abbreviations

BP Benzophenone

BSA Bovine serum albumin

DG Grafting degree (degree of grafting)

HEMA Hydroxyethyl methacrylate

HHL Half half-load

PES Polyether sulfone

PEG Polyethylene glycol

1. A method for reducing a tendency toward adsorption of molecules or biological cells from solutions or suspensions on a material surface placed in contact with the solution or suspension, is hereby characterized in that an organic or an inorganic support material with a modified surface is used as the material, whereby the surface modification occurs by in-situ polymerization of monomers, which are selected as a function of a property of the molecule or the cell, onto the surface.

2. The method according to claim 1, further characterized in that the in-situ polymerization is conducted by chemical or photochemical grafting, radical or ionic polymerization or polymer crosslinking.

3. The method according to claim 1 or 2, further characterized in that the selection of the monomer is made in such a way that the material receives a reduced tendency toward adsorption for proteins, peptides, peptoids, peptidomimetics, enzymes, antibodies, inoculation substances, nucleic acids, particularly DNA, RNA or plasmids carbohydrates, glucans, humic substances and/or derivatives thereof and/or for other organic molecules and/or small particles.

4. The method according to claim 1 or 2, further characterized in that the selection of the monomer is made in such a way that the material has a reduced tendency toward adsorption for microbial cells, particularly for bacteria, fungi, viruses, blood cells, tissue cells, and/or the like.

5. The method according to one of the preeding claims claim 1, further characterized in that the monomer is selected as a function of an electrostatic charge and/or a polarity and/or spatial structure of the monomer.

6. The method according to one of the preeding claims claim 1, further characterized in that the monomer is particularly selected from the group comprising methyl methacrylate, methyl acrylate, hydroxyethyl methacrylate, polyethylene glycol monomethacrylate of different chain lengths, N-isopropylacrylamide, diethylacrylamide, methacrylic acid, acrylic acid, acrylamide propanesulfonic acid, carboxylic acid derivatives with polymerization-capable groups, sulfonic acid derivatives with polymerization-capable groups, phosphoric acid derivatives with polymerization-capable groups, styrene sulfonic acid, styrene phosphoric acid, polymerization-capable ammonium, sulfonium and phosphonium derivatives, bi- and polyfunctional monomers, polymerisation-capable derivatives based on polyimides, heparin, fluorinated polymerization-capable monomers, monomers based on amino acids, carbohydrates, acrylamide, polymerization-capable detergents, alkyls of different chain lengths with polymerization-capable groups, hexyl methacrylate, tert-butyl methacrylate.

7. The method according to one of claims 1 to 2, further characterized in that an organic polymer material is used as the support material, particularly polysulfone, polyether sulfone, polyolefin, as well as polypropylene or polyethylene, polyamide, polyester, polycarbonate, polyacrylonitrile, polyvinylidene fluoride, polytetrafluorethylene, polyacrylate, polyacrylamide, cellulose, amylose, agarose, or a derivative thereof.

8. The method according to one of claims 1 to 2, further characterized in that an inorganic polymer, particularly metal, glass, silicate, ceramic, or the like is used as the support material.

9. The method according to claim 8, further characterized in that the support material is chemically pretreated by in-situ polymerization of the monomer or is coated with an organic polymer material prior to the surface modification.

10. The method according to one of claims 1 to 2, further characterized in that the material is used for porous membranes that are utilized for the filtration or dialysis of the solution or suspension.

11. The method according to claim 10, further characterized in that the membrane is an ultra- or microfiltration membrane, particularly made of an organic polymer material, with a symmetric or asymmetric pore structure and a pore size in a range of nm to μm.

12. The method according to one of claims 1 to 2, further characterized in that the material is used for porous materials that are in contact with the solution or suspension, particularly sintered materials, such as ceramic membranes, or non-porous materials, particularly for films, foils, flexible tubings, pipelines, dialysis materials, receptacles, catheters, infusion needles, drainage systems, medical implants, reactors, or the like.

13. A method for the production of a material with reduced tendency toward adsorption for molecules or biological cells from solutions or suspensions, which is suitable for conducting the method according to one of claims 1 to 42, is hereby characterized in that the surface of a support material is modified by in-situ polymerization of monomers, which are selected as a function of a property of the molecule or the cell, onto the surface.

14. The method according to claim 13, further characterized in that the in-situ polymerization is conducted by chemical or photochemical grafting, radical or ionic polymerization or polymer crosslinking.

15. Use of the method according to one of claims 12 in food technology for materials for filtration, particularly sterile or clear filtration of liquid nutrients or drinks, particularly of beer, wine, fruit juices or dairy products.

16. Use of the method according to one of claims 12 in medical technology, wherein the material is used for objects which are found in contact with patients, particularly with tissues or body fluids of any type.

17. Use of a method according to one of claims 12 in biotechnology or in the drug industry, wherein the material is used particularly for articles for the filtration of fluids, for the concentration of substances from fluids, for de-salting, for dead-end filtration, in cross-flow applications, or the like.

18. Use of a method according to one of claims 12 in wastewater purification, particularly for the purification of municipal sewage, wastewater from technical processes in industry or wastewater of medical equipment.

19. Use of a method according to one of claims 12 for articles that come into contact with bodies of water, particularly ship hulls.
